(19) United States
(12) Patent Application Publication
(10) Pub. No.: US 2026/0200072 A1
(43) Pub. Date: Jul. 16, 2026

(54) MOBILE ROBOT

(71) Applicant: RAINBOW ROBOTICS INC., Daejeon (KR)

(72) Inventors: Dong Seop LIM, Daejeon (KR); Jeong Soo LIM, Daejeon (KR); Tae Hyoung LEE, Daejeon (KR); Byung Ryung YOU, Daejeon (KR)

(21) Appl. No.: 19/525,980

(22) PCT Filed: Oct. 2, 2024
(86) PCT No.: PCT/KR2024/096230

§ 371 Date: Apr. 3, 2026

(30) Foreign Application Priority Data
Oct. 10, 2023 (KR) 10-2023-0134508
Oct. 10, 2023 (KR) 10-2023-0134509

(51) Int. Cl. B25J 5/00; A47B 31/00; B25J 9/00; B25J 11/00

(52) U.S. Cl. CPC B25J 5/007; A47B 31/00; B25J 9/0009; B25J 11/008

(57) ABSTRACT

A mobile robot according to an embodiment of the present disclosure may include a robot moving body and a plurality of drive wheels mounted on a lower end of the robot moving body, wherein each of the plurality of drive wheels includes a rotation shaft axially coupled to a drive motor fixed to a wheel bracket provided on a bottom surface of the robot moving body, and a wheel member including a second fitting member provided in a shape corresponding to a first fitting member provided at an end of the rotation shaft, into which a portion of the first fitting member is fitted and a portion of which is fitted into the first fitting member to rotate together with the rotation shaft when the drive motor is driven.

### TECHNICAL FIELD

The present disclosure relates to a robot, and more particularly, to a mobile robot that can be utilized for serving or logistics.

### BACKGROUND ART

In recent years, service provision using serving robots has been increasing in stores such as restaurants.

This is because service response problems have frequently occurred in recent years and the burden of labor costs has increased as the minimum wage has been raised every year, so unmanned systems that eliminate the need for employees are progressing rapidly, and as a result, unmanned comprehensive information guidance systems such as kiosks and serving robots that serve food and collect an empty bowl are being actively developed.

In detail, tasks such as taking orders, delivering ordered food to the appropriate table, and collecting an empty bowl from the table were previously performed by staff members, but now can be done by serving robots.

In particular, in the case of buffet restaurants or the like where customers serve themselves and eat at their own tables, there are many empty bowls, but there are limits to how quickly employees can clear them away, so the buffet restaurants or the like are increasingly utilizing serving robots to collect empty bowls.

A serving robot according to a conventional embodiment may include a movable robot body, a drive part that drives the robot body, a sensor part for location recognition and obstacle detection, and a tray for loading a bowl containing food or collecting an empty bowl.

However, in the case of conventional serving robots, most of them has a structure in which a tray mounted on the robot body is fixed in one location, so there is a structural limitation that it is not easy to adjust the location up and down. Moreover, when maintenance of internal parts is required, there are inconveniences such as having to lay the robot down or remove most of the parts because access to the internal parts is not easy.

In addition, foreign substances such as hair may be caught in a drive wheel or caster mounted on a lower end of the robot body, and there is also a structural complexity of having to completely separate the drive wheel from the robot body to remove the foreign substances.

Accordingly, there is a need for the development of a serving robot with a new configuration that can easily and selectively adjust the location of the tray, facilitate maintenance work of parts, and moreover easily remove foreign substances when foreign substances are caught in the drive wheel.

### DISCLOSURE OF INVENTION

### Technical Problem

An embodiment of the present disclosure provides a mobile robot in which foreign substances such as hair may be caught in the drive wheel during a long-term operation, and work such as maintenance may be smoothly performed by easily separating a wheel member from a rotation shaft, removing foreign substances, and then allowing the wheel member to be easily fitted into the rotation shaft.

A problem to be solved by the present disclosure is not limited to the above-mentioned problem(s), and other problem(s) that are not mentioned herein will be clearly understood by those skilled in the art from the following description.

### Technical Solution

A mobile robot according to an embodiment of the present disclosure may include a robot moving body and a plurality of drive wheels mounted on a lower end of the robot moving body, wherein each of the plurality of drive wheels includes a rotation shaft axially coupled to a drive motor fixed to a wheel bracket provided on a bottom surface of the robot moving body, and a wheel member including a second fitting member provided in a shape corresponding to a first fitting member provided at an end of the rotation shaft, into which a portion of the first fitting member is fitted and a portion of which is fitted into the first fitting member to rotate together with the rotation shaft when the drive motor is driven.

### Advantageous Effects

According to an embodiment of the present disclosure, foreign substances such as hair may be caught in a drive wheel during a long-term operation, and work such as maintenance may be smoothly performed by easily separating a wheel member from a rotation shaft, removing foreign substances, and then allowing the wheel member to be easily fitted into the rotation shaft.

### BRIEF DESCRIPTION OF THE DRAWINGS

FIG. 1 is a perspective view of a mobile robot according to one embodiment of the present disclosure.

FIG. 2 is a perspective view of the mobile robot of FIG. 1 from behind and a partially enlarged perspective view of a portion thereof.

FIG. 3 is a partially exploded perspective view of FIG. 1.

FIG. 4 is a view showing a drive wheel and an auxiliary wheel of the mobile robot shown in FIG. 1.

FIG. 5 is an enlarged view of the drive wheel in FIG. 4.

FIG. 6 is a view showing a rotation shaft and a wheel member of FIG. 5, respectively, viewed from different directions to illustrate a coupling therebetween.

FIG. 7 is a view showing a separated state of the auxiliary wheel shown in FIG. 4.

FIG. 8 is a view showing a state in which a plate is separated from a tray shown in FIG. 1.

### BEST MODE FOR CARRYING OUT THE INVENTION

Advantages and/or features of the present disclosure, and methods of accomplishing the same will be clearly understood with reference to the following embodiments described below in detail in conjunction with the accompanying drawings. However, the present disclosure is not limited to those embodiments disclosed below but may be implemented in various different forms. It should be noted that the present embodiments are merely provided to make a full disclosure of the invention and also to allow those skilled in the art to know the full range of the invention, and therefore, the present disclosure is to be defined only by the scope of the appended claims. The same reference numerals refer to the same elements throughout the specification.

Embodiments of the present disclosure will be described in detail with reference to the accompanying drawings.

Hereinafter, embodiments of the present disclosure will be described as an example in which a mobile robot according to the present disclosure is a serving robot, but the present disclosure is not limited thereto, and can be applied to various mobile robots such as an autonomous mobile robot (AMR) and an automated guided vehicle (AGV) that are not fixed in a physical location and have the ability to move in a surrounding environment.

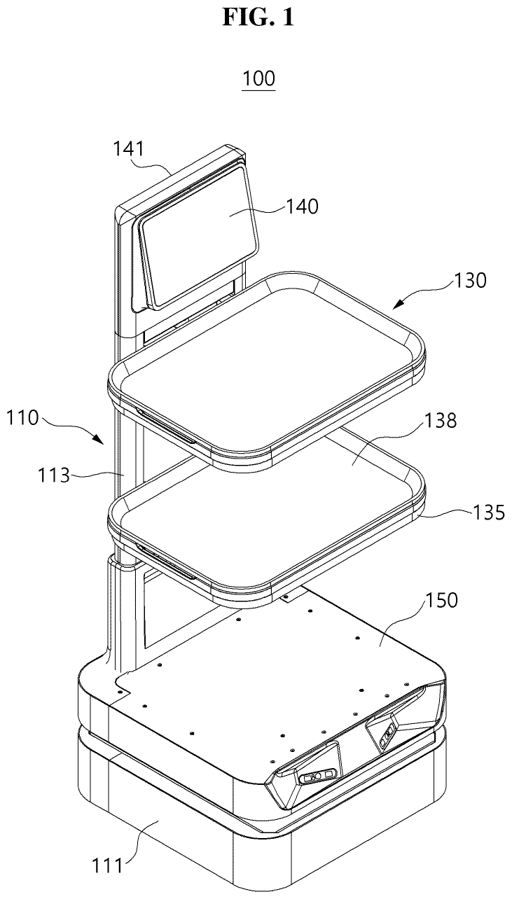

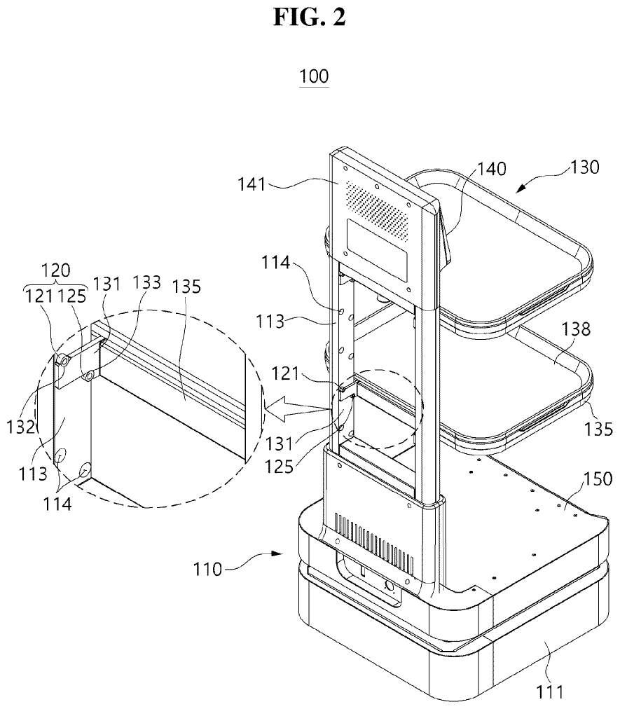

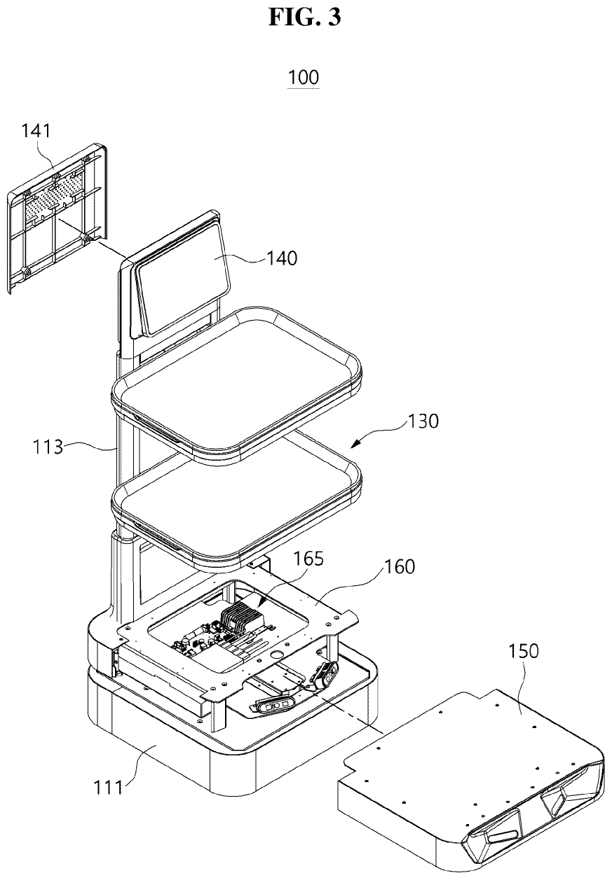

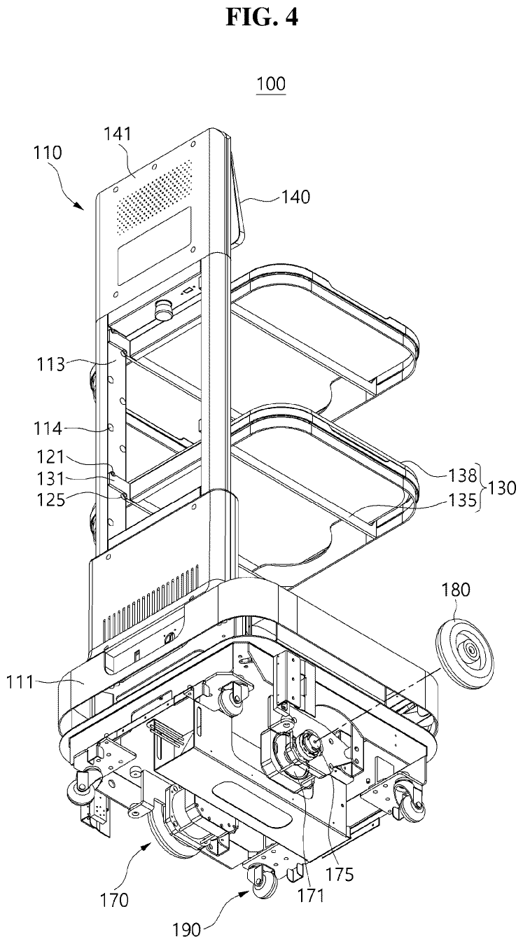

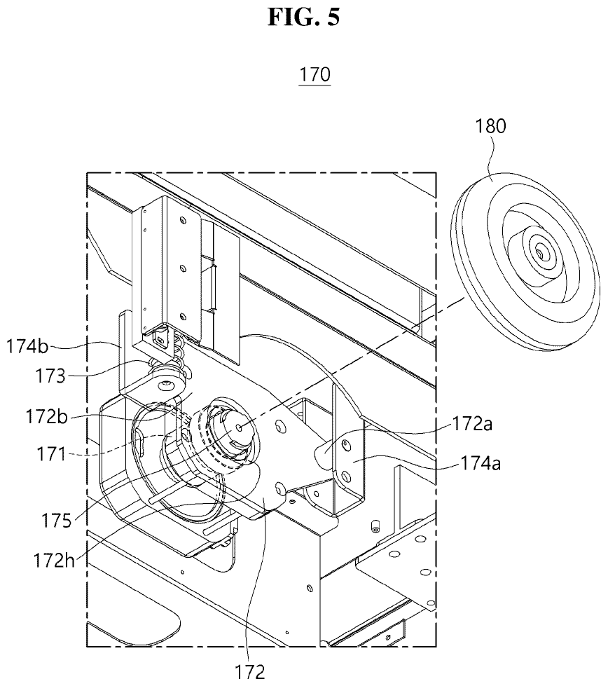

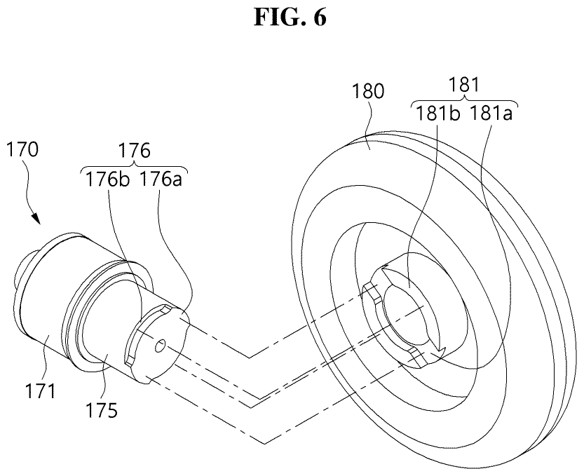

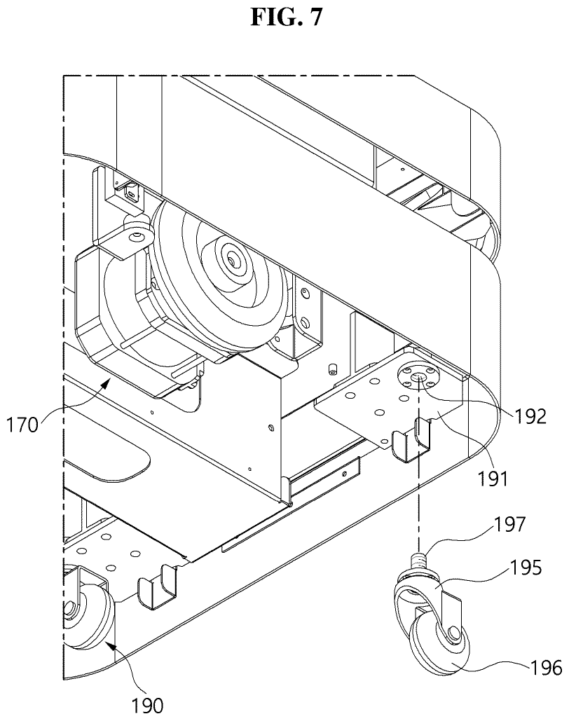

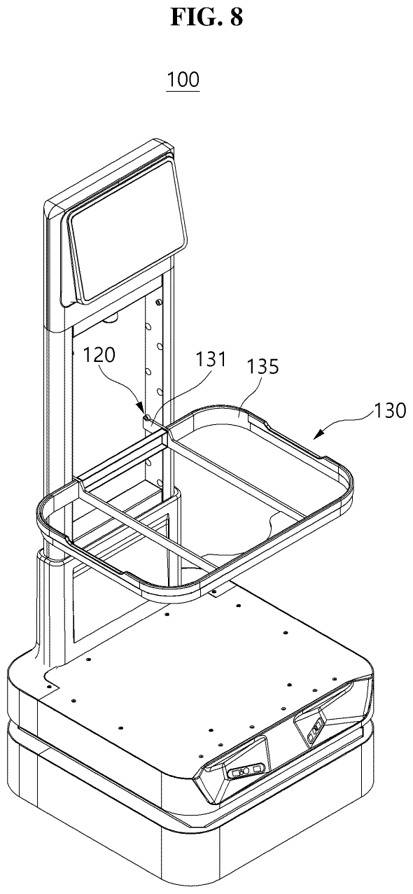

FIG. 1 is a perspective view of a mobile robot according to one embodiment of the present disclosure, FIG. 2 is a perspective view of the mobile robot of FIG. 1 from behind and a partially enlarged perspective view of a portion thereof, FIG. 3 is a partially exploded perspective view of FIG. 1, FIG. 4 is a view showing a drive wheel and an auxiliary wheel of the mobile robot shown in FIG. 1, FIG. 5 is an enlarged view of the drive wheel in FIG. 4, FIG. 6 is a view showing a rotation shaft and a wheel member of FIG. 5, respectively, viewed from different directions to illustrate a coupling therebetween, FIG. 7 is a view showing a separated state of the auxiliary wheel shown in FIG. 4, and FIG. 8 is a view showing a state in which a plate is separated from a tray shown in FIG. 1.

As shown in these drawings, a serving robot 100 according to one embodiment of the present disclosure may include a robot moving body 110 forming a basic frame, a drive wheel 170 as a drive part that generates a driving force for driving the robot moving body 110, a sensor part (not shown) that recognizes the location of the robot moving body 110 and detects an obstacle when it moves, a touch-type display unit 140, and a control part (not shown) that controls them.

For example, when an empty bowl collect signal is given to the serving robot 100 from a table, the serving robot 100 may move to that table under the control of the drive part by the control part while recognizing the location and detecting an obstacle by the sensor part, and may move to a next command location after collecting the empty bowl.

To this end, the serving robot 100 of this embodiment may move accurately and smoothly by having the drive wheel 170, and also efficiently provide items such as food to that table, as well as increase a collection efficiency of empty bowls or the like by having a structure in which a plurality of trays 130 are selectively coupled.

The robot moving body 110 of this embodiment may include a base member 111 on which a plurality of drive wheels 170 and auxiliary wheels 190 are mounted and two standing members 113 that are arranged in parallel to stand up on one side of an upper end of the base member 111, as shown in FIGS. 1 to 4.

In detail, a mounting bracket 160 on which a number of parts 165 are mounted in an orderly manner may be mounted on the upper end of the base member 111 while being covered by a cover 150, and the touch-type display part 140 may be mounted on an upper end of two standing members 113, and a configuration and mounting structure thereof will be described later.

Referring to FIGS. 1 and 2, the robot moving body 110 of this embodiment may have a plurality of tray coupling parts 120 to which a tray 130 for loading items are selectively and detachably coupled.

In detail, the plurality of tray coupling parts 120 of this embodiment may be provided to be spaced apart in a height direction along inner surfaces of the two standing members 113, thereby allowing the tray 130 to be coupled to a selected tray coupling part 120 among the plurality of tray coupling parts 120.

As shown in FIG. 2, each of the plurality of tray coupling parts 120 may include a first hooked member 121 provided at a rear end portion on the inner surface of the standing member 113, and a second hooked member 125 provided at a lower side compared to the first hooked member 121 at a front end portion on the inner surface of the standing member 113.

Here, the first hooked member 121 and the second hooked member 125 may be provided in a cylindrical protrusion shape, and may be coupled to a selected coupling hole 114 among the coupling holes 114 regularly provided along a length direction of the standing member 113.

Referring to FIG. 2, a structure of total five coupling holes 114 may be provided on the standing member 113 so as to allow a total of five tray coupling parts 120 to be coupled thereto, and in the case of FIG. 2, it shows a state in which the tray coupling parts 120 are selectively coupled to the coupling holes 114 provided at the top and the fourth coupling holes 114, respectively, in the structure of the five coupling holes 114, and the trays 130 are mounted thereon.

As shown in the enlarged view of FIG. 2, a pair of hooking members 131 provided in parallel at a rear end of the tray 130 may be engaged with the first hooked member 121 and the second hooked member 125 provided in parallel on the two standing members 113, respectively, and in the case of this embodiment, when the hooking member 131 is inserted diagonally between the hooked members 121, 125 and then located horizontally, the hooking member 131 may be caught in the hooked members 121, 125, thereby allowing the tray 130 to be firmly coupled to the tray coupling part 120.

As described above, the first hooked member 121 has a cylindrical protrusion shape, and a semicircular hooking groove 132 (see FIG. 2) may be provided in an area of the hooking member 131 to be caught in the first hooked member 121 so as to allow the hooking member 131 to be maintained horizontally when the first hooked member 121 is caught in the hooking groove 132, and thus the entire tray 130 may be maintained in a horizontal state.

In addition, when the first hooked member 121 is caught in the hooking groove 132 of the hooking member 131, the second hooked member 125 is blocked in a blocking portion 133 that is provided in a stepped manner on one side of a lower end of the hooking member 131, and through this, the location of the hooking member 131 with respect to the second hooked member 125 may be fixed, thereby firmly maintaining the coupling of the tray 130 to the tray coupling part 120.

Meanwhile, a process of separating the tray 130 from the tray coupling part 120 may also be carried out smoothly. When a front portion of the tray 130 is lifted as a whole, the hooking groove 132 is removed from the first hooked member 121 and the blocking portion 133 is lifted from the second hooked member 125, and in this way, when the hooking member 131 of the tray 130 is located diagonally and then the entire tray is pulled out diagonally, the tray 130 may be easily separated from the tray coupling part 120.

In this way, in the case of this embodiment, the plurality of tray coupling parts 120 may be provided in a length direction of the standing member 113, and the tray 130 may be simply and firmly coupled to a selected tray coupling part 120 among them, thereby not only efficiently providing products such as food and collecting empty bowls, but also easily performing cleaning, maintenance, or the like for the entire tray 130 when required.

Meanwhile, the serving robot 100 of this embodiment may stably cover a portion provided with each part using an integrated cover structure, and also easily remove the cover when necessary, thereby facilitating maintenance of parts.

Referring to FIG. 3, the display part 140 of this embodiment may be provided on the upper end of the robot moving body 110, and through this, an operating status of the serving robot 100 in this embodiment may be shown to a user or the like, and various information may be provided, and in addition, when a user, such as a customer, touches the touch-type display part 140, that function may be carried out.

Various internal parts may be built into the display part 140, and a rear cover member 141 may be detachably coupled to a rear end of the display part 140 to cover the internal parts and to easily separate the rear cover member 141 when maintenance or replacement is required so as to perform that work.

In addition, as shown in FIG. 3, the base member 111 on which a plurality of drive wheels 170 are mounted may be provided on a lower end of the robot moving body 110, and a mounting bracket 160 for mounting a plurality of parts 165 to operate the serving robot 100 of this embodiment may be provided on an upper end of the base member 111.

For example, as will be described in detail later, the drive wheel 170 that generates a driving force may be mounted on the base member 111, and a sensor part, a control part, and the like may be provided on the mounting bracket 160.

In addition, the cover 150 may be provided to completely cover the mounting bracket 160 on which a plurality of parts 165 are mounted, the cover 150 of this embodiment may have a box shape with the side and bottom facing rearward open as shown in FIG. 3, and the entire cover 150 may move laterally to cover the mounting bracket 160, and fix between the cover 150 and the mounting bracket 160 using a fixing member such as a bolt, thereby allowing the coupling of the cover 150 to the mounting bracket 160 to be made simple and sturdy.

That is, the cover 150 may be fitted sideways toward the mounting bracket 160 to cover all of the parts mounted on the mounting bracket 160, and conversely, when maintenance or replacement of the parts is required, the cover 150 may be easily separated from the mounting bracket 160 by removing the bolts and then pulling the cover 150 sideways.

Although not shown, a pad made of a rubber material, for example a silicone pad, may be detachably coupled to an upper surface of the cover 150. A silicon pad may be provided to almost cover the upper surface of the cover 150, and as described above, when carrying food through the tray 130 or collecting empty bowls, food or the like may fall and get on the silicone pad, and in this case, the silicone pad may be separated and easily cleaned.

Meanwhile, the serving robot 100 of this embodiment may further include, as described above, a plurality of drive wheels 170 mounted on a lower end of the base member 111 of the robot moving body 110 as a drive part, and four auxiliary wheels 190 respectively coupled to four corner areas of a bottom surface of the base member 111.

Through such a drive structure, for example, when a drive command is given by the control part, the drive wheel 170 may be driven at the commanded speed and direction, and accordingly, the serving robot 100 of this embodiment may be moved to that location.

Referring to FIG. 4, a plurality of drive wheels 170 may be a pair of drive wheels 170 mounted at both ends of the center of the bottom surface of the base member 111 of the robot moving body 110, and four auxiliary wheels 190 may be respectively coupled to the four corner areas of the bottom surface of the base member 111, thereby balancing the drive structure of the serving robot 100 of this embodiment.

Referring to FIGS. 4 to 6, the plurality of drive wheels 170 of this embodiment may each include a rotation shaft 175 axially coupled to a drive motor 171 fixed to a wheel bracket 172 provided on the bottom surface of the base member 111 of the robot moving body 110, and a wheel member 180 including a second fitting member 181 provided in a shape corresponding to a first fitting member 176 provided at an end of the rotation shaft 175, into which a portion of the first fitting member 176 is fitted and a portion of which is fitted into the first fitting member 176 to rotate together with the rotation shaft 175 when the drive motor 171 is driven.

By this configuration, a driving force of the drive motor 171 may be directly transmitted to the wheel member 180 by simply but firmly coupling the wheel member 180 to the rotation shaft 175 so as not to allow the wheel member 180 to rotate idle with respect to the rotating shaft 175, thereby smoothly performing the movement of the serving robot 100 of this embodiment.

As described above, the first fitting member 176 of the rotation shaft 175 and the second fitting member 181 of the wheel member 180 may have a structure in which a portion thereof is inserted alternately with respect to each other so as to provide a solid coupling therebetween.

First, the first fitting member 176 of the rotation shaft 175 may, as shown in FIGS. 5 and 6, include a first protruding portion 176a symmetrically provided to have the same outer surface as that of an axial portion of the rotation shaft 175 provided in a cylindrical shape, and a first recessed portion 176b symmetrically provided between the first protruding portions 176a, the first recessed portion 176b being cut inward from the first protruding portion 176a to have a smaller outer diameter than the first protruding portion 176a.

That is, the first protruding portion 176a may be provided in a symmetrically cut-off circular shape, and the first recessed portion 176b may be provided in a symmetrically circular shape between the first protruding portions 176a so as to have a smaller diameter than the first protruding portion 176a, and a connection point between the first protruding portion 176a and the first recessed portion 176b forms a step so as to allow a step portion to be caught by the second fitting member 181 to be described later, thereby directly transmitting the driving force.

Meanwhile, the second fitting member 181 of the wheel member 180 in this embodiment may be provided in a hollow cylindrical shape protruding in an axial direction from an inner center of the wheel member 180, and may include a second recessed portion 181a having both sides symmetrically opened to allow the first protruding portion 176a to be fitted thereinto, and a second protruding portion 181b symmetrically provided between the second recessed portions 181a and fitted into the first recessed portion 176b, as shown in FIGS. 5 and 6.

Through this, when the first fitting member 176 and the second fitting member 181 are coupled to each other, the first protruding portion 176a of the first fitting member 176 and the second recessed portion 181a of the second fitting member 181 may be fitted into each other, and the first recessed portion 176b of the first fitting member 176 and the second protruding portion 181b of the second fitting member 181 may be fitted into each other, thereby simply and firmly coupling the wheel member 180 to the rotation shaft 175.

In addition, a stepped portion of the first fitting member 176 and a stepped portion of the second fitting member 181 may be in contact with each other, thereby preventing the wheel member 180 from rotating idle with respect to the rotation shaft 175 as well as directly transmitting a rotational motion of the rotation shaft 175 to the wheel member 180.

Through this, for example, foreign substances such as hair may be caught in the drive wheel 170 during a long-term operation the serving robot 100, and work such as maintenance, replacement or the like may be smoothly performed by conveniently separating the wheel member 180 from the rotating shaft 175, and removing the foreign substances, and then allowing the wheel member 180 to be easily fitted into the rotation shaft 175.

Meanwhile, since the wheel bracket 172 on which the drive wheel 170 of this embodiment is mounted has an elastic structure, it may absorb an impact generated during the driving of the drive wheel 170. Referring to FIG. 5, the rotation shaft 175 of the drive motor 171 may be coupled through a through hole 172h provided in the wheel bracket 172 so as to allow the drive motor 171 to be mounted with respect to the wheel bracket 172.

Referring to FIG. 5, one side 172a of the wheel bracket 172 may be rotatably coupled to a first fixed bracket 174a provided on the bottom surface of the base member 111 of the robot moving body 110, and an opposite side 172b of the wheel bracket 172 may be coupled to an elastic member 173 of a second fixed bracket 174b provided on the bottom surface of the base member 111.

Through this, the wheel bracket 172 may rotate to some extent around a connection portion to the first fixed bracket 174a, and the opposite side of the wheel bracket 172 may elastically move up and down around a coupling portion to the elastic member 173 to absorb an impact or the like generated during the driving of the drive wheel 170 by the elastic member 173, thereby enabling stable movement.

Meanwhile, the serving robot 100 of this embodiment may include, in addition to the drive wheel 170, a total of four auxiliary wheels 190 that are respectively coupled to four corner areas on the bottom surface of the base member 111, thereby more smoothly moving the serving robot 100.

The auxiliary wheel 190 of this embodiment may include a mounting plate 191 mounted on the bottom surface of the base member 111 of the robot moving body 110 to have a screw hole 192 formed with a female thread, and a wheel mounting member 195 provided with a male thread 197 corresponding to the female thread of the screw hole 192, and rotatably coupled to an auxiliary wheel member 196 that rotates together during the driving of the drive wheel 170, as shown in FIGS. 4 and 7.

The wheel mounting member 195 may be coupled to the mounting plate 191 by one-way rotation of the male screw thread 197 of the wheel mounting member 195 with respect to the female screw thread of the screw hole 192, or the wheel mounting member 195 may be separated from the mounting plate 191 by the other-way rotation.

In other words, since the coupling and separation of the auxiliary wheels 190 is facilitated, when some of the auxiliary wheels 190 need to be replaced or maintained, that work may be easily performed.

Meanwhile, as shown in FIG. 8, the tray 130 of this embodiment may include a tray frame 135 integral with the aforementioned hooking member 131, and a plate 138 (see FIG. 1) having a shape corresponding to a frame of the tray frame 135 may be detachably coupled to the tray frame 135.

In other words, the plate 138 may be easily placed on and also lifted from the tray frame 135, thereby facilitating the cleaning of the tray 138 as well as the cleaning of the tray frame 135.

Although a specific embodiment according to the present disclosure have been described so far, various modifications may, of course, be made thereto without departing from the scope of the present disclosure. Therefore, the scope of the present disclosure should not be limited to the described embodiments, but should be defined not only by the claims described below but also by equivalents to the claims.

Although the present disclosure has been described with reference to limited embodiments and drawings as shown above, the present disclosure is not limited to the above embodiments, and various modifications and variations may be made from the above description by those skilled in the art to which the present disclosure pertains. Accordingly, the concept of the present disclosure should be understood only by the claims described below, and all equivalents or equivalent modifications thereof fall within the scope of the present disclosure.

1. A mobile robot comprising:
a robot moving body; and
a plurality of drive wheels mounted on a lower end of the robot moving body,
wherein each of the plurality of drive wheels comprises:
a rotation shaft axially coupled to a drive motor fixed to a wheel bracket provided on a bottom surface of the robot moving body; and
a wheel member comprising a second fitting member provided in a shape corresponding to a first fitting member provided at an end of the rotation shaft, into which a portion of the first fitting member is fitted and a portion of which is fitted into the first fitting member to rotate together with the rotation shaft when the drive motor is driven.

2. The mobile robot of claim 1, wherein the first fitting member of the rotation shaft comprises:
a first protruding portion symmetrically provided to have the same outer surface as that of an axial portion of the rotation shaft; and
a first recessed portion symmetrically provided between the first protruding portions; the first recessed portion being cut inward from the first protruding portion to have a smaller outer diameter than the first protruding portion.

3. The mobile robot of claim 2, wherein the second fitting member of the wheel member is provided in a hollow cylindrical shape protruding in an axial direction from an inner center of the wheel member, the second fitting member comprising:
a second recessed portion having both sides symmetrically opened to allow the first protruding portion to be fitted thereinto; and
a second protruding portion symmetrically provided between the second recessed portions and fitted into the first recessed portion.

4. The mobile robot of claim 1, wherein the rotation shaft of the drive motor is coupled through a through hole provided in the wheel bracket, and the drive motor is mounted to the wheel bracket, and
wherein one side of the wheel bracket is rotatably coupled to a first fixed bracket provided on a bottom surface of the robot moving body, and the other side of the wheel bracket is elastically and movably coupled to an elastic member of a second fixed bracket provided on the bottom surface of the robot moving body.

5. The mobile robot of claim 1, wherein the plurality of drive wheels are a pair of drive wheels mounted on both ends of the center of the bottom surface of the robot moving body.

6. The mobile robot of claim 1, further comprising:
four auxiliary wheels that are respectively coupled to four corner areas of the bottom surface of the robot moving body.

7. The mobile robot of claim 6, wherein the auxiliary wheel comprises:
a mounting plate mounted on the bottom surface of the robot moving body, and having a screw hole formed with a female screw thread; and
a wheel mounting member having a male screw thread coupled to the screw hole, and to which an auxiliary wheel member that rotates together when the drive wheel is driven is rotatably coupled.

8. The mobile robot of claim 7, wherein the wheel mounting member is coupled to or separated from the mounting plate by rotation of the male screw with respect to the screw hole.

9. The mobile robot of claim 1, wherein the lower end of the robot moving body is provided with a base member on which the plurality of drive wheels are mounted, and
wherein a mounting bracket for mounting a plurality of parts is provided on an upper part of the base member, and the mounting bracket is covered with a cover.

10. The mobile robot of claim 9, wherein the cover has a shape with one side and bottom open, moves laterally to cover the mounting bracket, and fixes the cover to the mounting bracket using a fixing member.
